(19) United States
(12) Patent Application Publication
(10) Pub. No.: US 2012/0182220 A1
(43) Pub. Date: Jul. 19, 2012

(54) MOBILE TERMINAL INCLUDING AN IMPROVED KEYPAD FOR CHARACTER ENTRY AND A USAGE METHOD THEREOF

(75) Inventor: Zhen WU, Beijing (CN)

(73) Assignee: Samsung Electronics Co., Ltd., Suwon-si (KR)

(21) Appl. No.: 13/353,811

(22) Filed: Jan. 19, 2012

(30) Foreign Application Priority Data
Jan. 19, 2011 (CN) 201110026812.X
Jan. 5, 2012 (KR) 10-2012-0001464

(51) Int. Cl. G06F 3/02; G06F 3/041

(52) U.S. Cl. 345/168

(57) ABSTRACT

A mobile terminal and a method of character entry, wherein the mobile terminal includes a keypad keys that receive a first input, wherein the keys correspond to characters; a display; and a processor that receives the first input through a key of the keypad, controls the display to display a level key that includes a set of characters corresponding to the key and displays each character of the set of characters in separate areas, where the separate areas correspond to the plurality of keys of the keypad, receives a second input through one of keys, and controls the display to display a character from the set of characters of the level key corresponding to the second input, as a character entry.

### PRIORITY

This application claims priorities under 35 U.S.C. §119(a) to Chinese Patent Application Serial No. 201110026812.X, which was filed in the State Intellectual Property Office on Jan. 19, 2011 and Korean Patent Application Serial No. 10-2012-0001464, which was filed in the Korean Intellectual Property Office on Jan. 5, 2012, the entire disclosure of each of which is hereby incorporated by reference.

### BACKGROUND OF THE INVENTION

1. Field of the Invention

The present invention relates generally to input technologies for a terminal, and more particularly, to a keypad of a mobile terminal and a usage method of the keyboard.

2. Description of the Related Art

On a conventional mobile terminal 12 key keypad, eight of the numerical keys, i.e., 2-9, are also used as letter keys for character input. While this simple configuration allows for both number and text entry, the disadvantage of this arrangement is its efficiency. For example, if an English letter “S” is to be input, a user presses the 7 key, which includes PQRS, for four times. Even using predictive text software, if a Chinese character is to be input, e.g., a Chinese character “zan”, through spelling, a user presses the 9 key, which includes WXYZ, the 2 key, which is includes ABC, and the 6 key, which includes MNO. As a result, multiple combinations from these key entries, e.g., zan, yao, zao, yan, and wan, are presented to the user, but the user still must press a direction key, possibly many times, in order to select the desired Chinese character. Consequently, the character input can be very inefficient.

Further, a user often needs to shift modes of the mobile terminal when entering both text and numbers, which is inconvenient.

Even in newer smart phones, which utilize more of a computer style keyboard, i.e., a full-letter keypad including a “QWERTY” keyboard, size restrictions imposed on the keypads used in portable terminal create a number of problems, e.g., the keys of the keypad are too small.

In addition, the above-described two kinds of keypads have a common disadvantage, i.e., a specific letter or numeral is configured on a specific key. Consequently, if a certain key is used more often than the other keys, that key will age and possibly damage earlier, influencing the service life of the terminal device.

### SUMMARY OF THE INVENTION

The present invention is designed to address at least the problems and/or disadvantages described above and to provide at least the advantages described below.

Accordingly, an aspect of the present invention is to provide a mobile terminal keypad with which a user can rapidly input character information.

Another aspect of the present invention is to provide a character entry method and apparatus that enable all characters to be enter within two key presses.

In accordance with an aspect of the present invention, a mobile terminal is provided, which includes a keypad including a plurality of keys that receive a first input from a user, wherein the plurality of keys correspond to a plurality of characters; a display; and a processor that receives the first input from the user through a key of the keypad, controls the display to display a level key, wherein the level key includes a set of characters corresponding to the key and displays each character of the set of characters in separate areas, and the separate areas correspond to the plurality of keys of the keypad, receives a second input through one of the plurality of keys of the keypad, and controls the display to display a character from among the set of characters displayed in the separate areas of the level key corresponding to the second input received through the one of the plurality of keys of the keypad, as a character entry.

In accordance with another aspect of the present invention, a mobile terminal is provided, which includes a touch screen display that displays a virtual keypad including a plurality of keys that receive a first input from a user, wherein the plurality of keys correspond to a plurality of characters; and a processor that receives the first input from the user through a key of the keypad, controls the touch screen display to display a level key, wherein the level key includes a set of characters corresponding to the key and displays each character of the set of characters in separate selectable areas, receives a second input through one of the separate selectable areas, and controls the touch screen display to display a character from among the set of characters displayed in the separate selectable areas of level key corresponding to the second input, as a character entry.

In accordance with another aspect of the present invention, a method of character entry in a mobile terminal is provided. The method includes receiving a first input from a user through a key of a keypad including a plurality of keys, wherein the plurality of keys correspond to a plurality of characters; displaying a level key corresponding to the first input, wherein the level key includes a set of characters corresponding to the key and displays each character of the set of characters in separate areas, receiving a second input selecting a character from among the set of characters displayed in the separate areas of the level key, and displaying the character as a character entry.

### BRIEF DESCRIPTION OF THE DRAWINGS

The above and/or additional aspects, features, and advantages of the present invention will become apparent and more readily appreciated from the following description, when taken in conjunction with the accompanying drawings, in which:

FIG. 1 illustrates a keypad of a conventional mobile telephone;

FIG. 2 illustrates a keypad according to an embodiment of the present invention;

FIG. 3 illustrates a level one key according to an embodiment of the present invention;

FIG. 4 illustrates a level three key according to an embodiment of the present invention;

FIG. 5 illustrates a clip keypad A according to an embodiment of the present invention;

FIG. 6 illustrates a clip keypad B according to an embodiment of the present invention;

FIG. 7 illustrates a level zero keys on clip keypads according to embodiments of the present invention;

FIG. 8 illustrates level two keys on clip keypads according to embodiments of the present invention; and

FIG. 9 is a block diagram illustrating a mobile terminal according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In accordance with an embodiment of the present invention, an improved keypad for a mobile terminal is provided, on which at least one of the keys includes a numerical value and at least one character. For example, a key includes “2” and the characters “ABC”. When a key including a numerical value and at least one character is pressed, a corresponding level key is displayed in which each of the numerical value and the at least one character is arranged for selection by a key of the keypad. For example, using the above-described example of a key including “2” and the characters “ABC”, when this key selected on the keypad, a level key, i.e., a level 2 key, is displayed, where each of “2”, “A”, “B”, and “C” are arranged for selection by a different key of the keypad.

The mobile terminal includes but is not limited to a mobile phone, a Personal Data Assistant (PDA), a touchpad, a palmtop computer, etc.

More specifically, in accordance with an embodiment of the present invention, an improved keypad of a mobile terminal includes a plurality of keys, wherein each of the plurality of keys corresponds to a level key Dᵢ, where 0≦i≦N. On the level key Dᵢ, Zᵢ characters are displayed, where N is the number of levels, and M is the number of characters displayed on the keypad and

$$M = {\sum }_{i = 0}^{N - 1} {Z}_{i} .$$

Basically, the level key Dᵢ is adapted to input character information, wherein when the level key Dᵢ to which a specific character belongs is pressed, the Zᵢ characters on the level key Dᵢ are displayed on a screen of the mobile terminal to be quickly selected by a user when the user selects a specific character corresponding to its display on the level key Dᵢ.

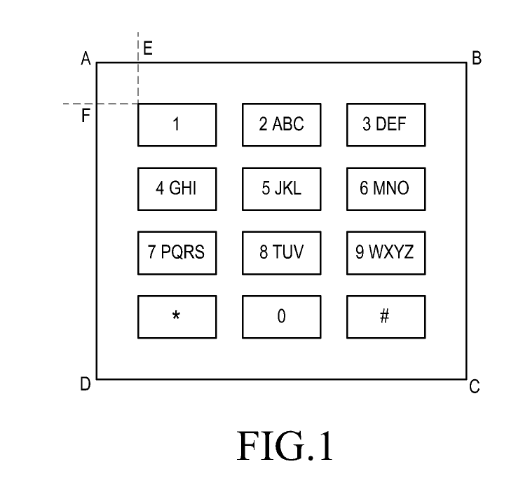

FIG. 1 illustrates a keypad of a conventional mobile telephone.

Referring to FIG. 1, each of keys 2-9 on the keypad also corresponds to 3 or 4 characters. However, there are a number of operational disadvantages for entering text using this basic configuration, as described above. Therefore, in accordance with an embodiment of the present invention, level keys are provided, which correspond to a group of characters, wherein the characters on the level key are distributed for selection using other keys of the keypad. Basically, each of the characters is displayed to correspond to a different key of the keypad to implement character input.

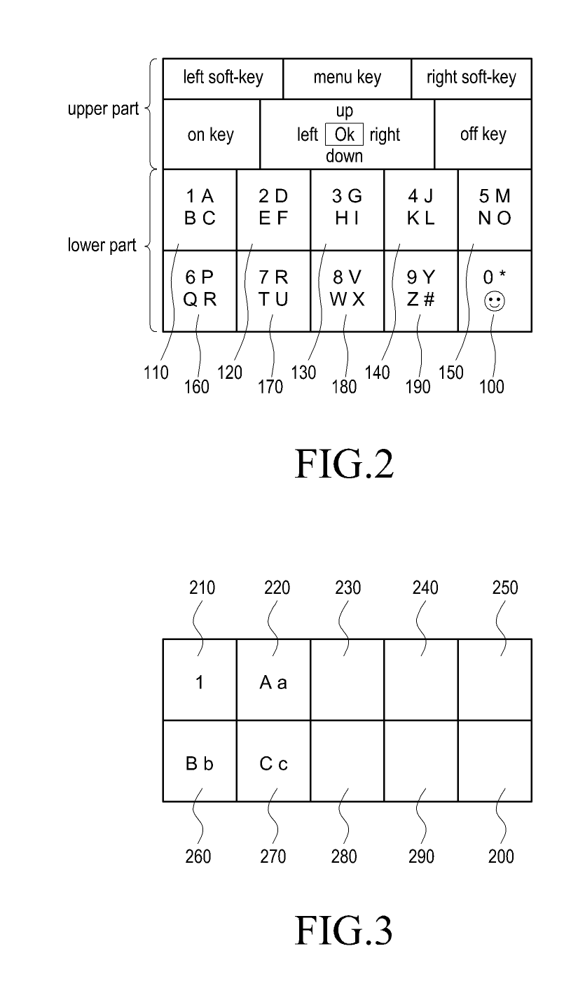

FIG. 2 illustrates a keypad according to an embodiment of the present invention.

Referring to FIG. 2, the keypad includes an upper part and a lower part. The lower part includes ten character keys 100 to 190, on each of which a character set and a numerical value are represented. The upper part includes conventional keys, which are not directed to character entry, e.g., power on key, a navigation key, etc. Accordingly, a description of the upper part will not be provided herein.

When one of character keys 100 to 190 is pressed, a screen of a terminal will display a level key including the character set and the numerical value displayed on the pressed character key, where each of the characters in the character set and the numerical value are displayed for selection using different keys of the keypad.

For convenience, a numerical value on a character key will be used to represent a level key corresponding to the character key. For example, the level key of the character key displaying “1ABC” will be referred to as “a level one key”.

FIG. 3 illustrates a level one key according to an embodiment of the present invention. Specifically, when a user presses character key 110 including “1ABC”, as illustrated in FIG. 2, the level one key illustrated in FIG. 3 is displayed.

Referring to FIG. 3, the level key includes display areas 200 to 290, which correspond to character keys 100 to 190, as illustrated in FIG. 2. Accordingly, “1” is displayed in area 210 for selection by a subsequent pressing of character key 110, “A” is displayed in area 220 for selection by a subsequent pressing of character key 120 (while “a” will be selected when character key 120 is pressed twice), “B” is displayed in area 260 for selection by a subsequent pressing of character key 160 (while “b” will be selected when character key 160 is pressed twice), and “C” is displayed in area 270 for selection by a subsequent pressing of character key 170 (while “c” will be selected when character key 170 is pressed twice).

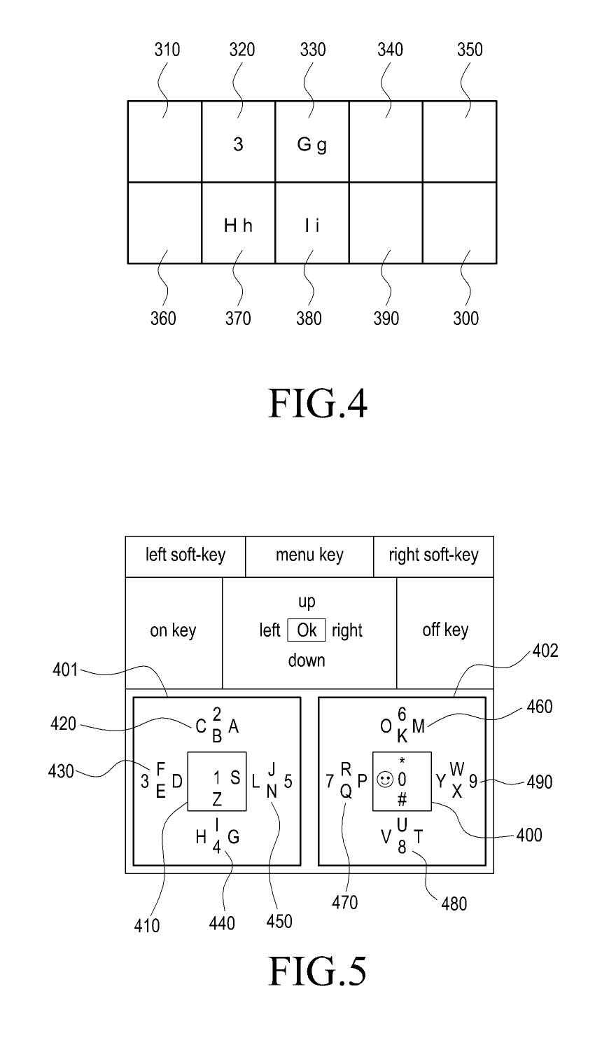

FIG. 4 illustrates a level three key according to an embodiment of the present invention. Specifically, when a user presses character key 130 including “3GHI”, as illustrated in FIG. 2, the level three key illustrated in FIG. 3 is displayed.

Referring to FIG. 4, the level key includes display areas 300 to 390, which correspond to character keys 100 to 190, as illustrated in FIG. 2. Accordingly, “3” is displayed in area 320 for selection by a subsequent pressing of character key 120, “G” is displayed in area 330 for selection by a subsequent pressing of character key 130 (while “g” will be selected when character key 130 is pressed twice), “H” is displayed in area 370 for selection by a subsequent pressing of character key 170 (while “h” will be selected when character key 170 is pressed twice), and “I” is displayed in area 380 for selection by a subsequent pressing of character key 180 (while “i” will be selected when character key 180 is pressed twice).

Alternatively, in a mobile terminal including a touch screen display, the numbers and characters displayed in areas 210, 220, 260, and 270 in FIG. 3, and in areas 320, 330, 370, and 380 in FIG. 4 can be selected by pressing the actual display areas displayed on the touch screen display, instead of pressing the corresponding character keys 110, 120, 130, 160, 170, and 180.

As another alternative, in a mobile terminal including a touch screen display that displays the keypad illustrated in FIG. 2, i.e., a terminal without a physical keypad, when one of the a character keys 100 to 190 are pressed on the touch screen, the lower part of the displayed keypad of FIG. 2 can be replaced with a corresponding level key. For example, the level keys illustrated in FIGS. 3 and 4 can be displayed in the lower part of the displayed keypad of FIG. 2. Alternatively, a corresponding level key can be displayed in addition to the displayed keypad of FIG. 2, e.g., in another area of the display or as a pop-up window.

Alternatively, instead of selecting an uppercase version or a lowercase version of a letter based on a number of key presses, as described above, the selection of the uppercase version or the lowercase version of a letter may be based on the length of a key press, e.g., an uppercase letter is entered for a long press and a lowercase letter is entered for a short press.

In accordance with an embodiment of the present invention, instead of simultaneously displaying both lowercase and uppercase versions of a letter in an area of a level key as illustrated in FIGS. 3 and 4, uppercase versions of a letter could be displayed on the level key for a predetermine time T, e.g., 2 second, and if a user does not select a character before T expires, the uppercase versions of the letters are replaced with lowercase version of the letters.

The above-described embodiments of present invention are not limited to the configurations of the keypad and the level keys illustrated in FIG. 1-3.

For example, the number of character keys and levels may be increased or decreased according to design and space requirements.

Generally, with fewer character keys, it is more beneficial to increase the areas of the keys, in order to facilitate a user inputting information.

In accordance with an embodiment of the present invention, in order to improve performance of a keypad, characters displayed on the level keys may meet one or more of the following conditions.

Condition 1

The number of characters Zᵢ displayed on each level key D is

$$[ \frac{M}{N} ] \leq {Z}_{i} \leq [ \frac{M}{N} ] + 1 ,$$

wherein, [ ] is a rounding operator.

Under Condition 1, the characters distributed on the level keys are averaged as much as possible, which will improve the input efficiency of the keypad and average the usage frequency of each key.

Condition 2

Each level key only has one number.

Under Condition 2, a phone number can be input as quickly as possible.

Condition 3

A character with high usage frequency and a character with low usage frequency are displayed together on a level key.

Generally, when a user uses the keypad, the usage frequency of the numbers and characters are different.

For example, numbers 6 and 8 have higher usage frequencies than number 4. Further, the usage frequency of English letters is: A: 8.19%, B: 1.47%, C: 3.83%, D:

3.91%, E: 12.25%, F: 2.26%, G: 1.71%, H: 4.57%, I: 7.10%, J: 0.14%, K: 0.41%, L: 3.77%, M: 3.34%, N: 7.06%, O: 7.26%, P: 2.89%, Q: 0.09%, R: 6.85%, S: 6.36%, T: 9.41%, U: 2.58%, V: 1.09%, W: 1.59%, X: 0.21%, Y: 1.58%, Z: 0.08%.

Accordingly, if a certain key is used frequently, the key will age more quickly and is more likely to damage. Therefore, based on the prior usage frequency data, by displaying a character with a high usage frequency and a character with a low usage frequency together on a level key, the level key will age better than a key including two characters with high usage frequencies.

For example, character E has the highest usage frequency, and thus can be placed on the same level key with number 4. Basically, the ultimate object is to make the usage frequency of all keys of the keypad to be as identical as possible.

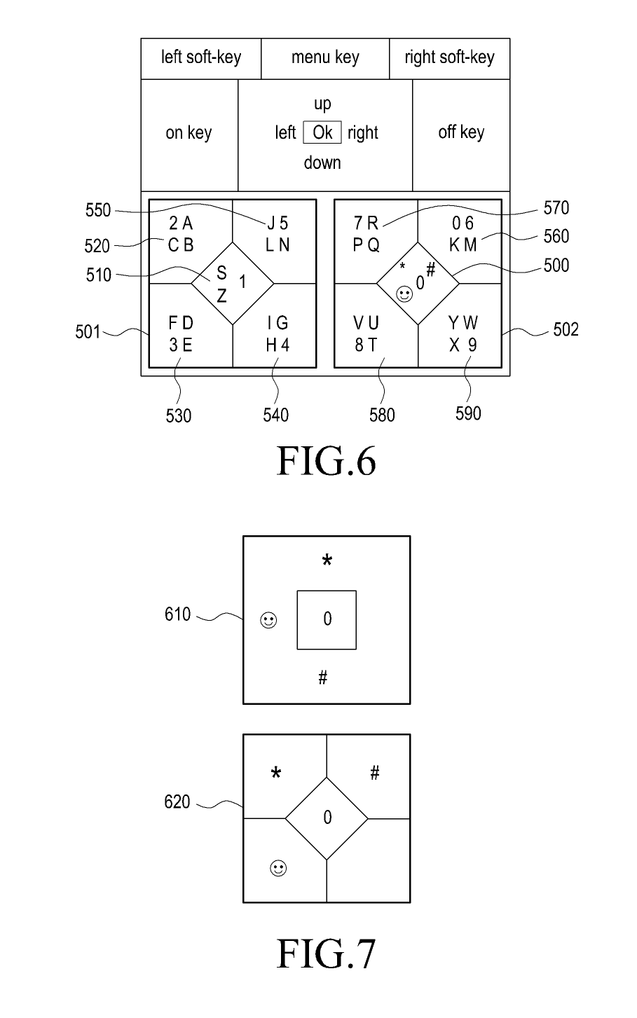

Different embodiments of keypads that are configured according to the usage frequencies of the numbers and characters will be described in more detail below with reference to FIGS. 5 and 6.

FIG. 4 illustrates a clip keypad A according to an embodiment of the present invention.

Referring to FIG. 5, a lower part of the clip keypad A includes a first clip key 401 and a second clip key 402. The first clip key 401 includes character keys 410, 420, 430, 440, and 450, and the second clip key 402 includes character keys 400, 460, 470, 480, and 490.

FIG. 6 illustrates a clip keypad B according to an embodiment of the present invention.

Referring to FIG. 6, a lower part of the clip keypad A includes a first clip key 501 and a second clip key 502. The first clip key 501 includes character keys 510, 520, 530, 540, and 550, and the second clip key 502 includes character keys 500, 560, 570, 580, and 590.

When one of character keys 400 to 490 or 500 to 590 is pressed, a screen of a terminal will display a level key including the character set and the numerical value displayed on the pressed character key, where each of the characters in the character set and the numerical value are displayed for selection using different keys of the keypad.

FIG. 7 illustrates level zero keys on clip keypads according to embodiments of the present invention.

Referring to FIG. 7, when a user presses character key 410 or 510 including “0 [symbol] *#”, as illustrated in FIGS. 5 and 6, the level zero key 610 or 620 is displayed. Each of the level keys 610 and 620 includes separate display areas for “0”, “ [symbol] ”, “*”, and “#”. Accordingly, in level keys 610 and 620 “0” is displayed in a center area for selection by a subsequent pressing of character key 410 or 510, “ [symbol] ” displayed in area for selection by a subsequent pressing of character key 470 or 580, “*” is displayed in area for selection by a subsequent pressing of character key 460 or 570, and “#” is displayed in area for selection by a subsequent pressing of character key 480 or 560.

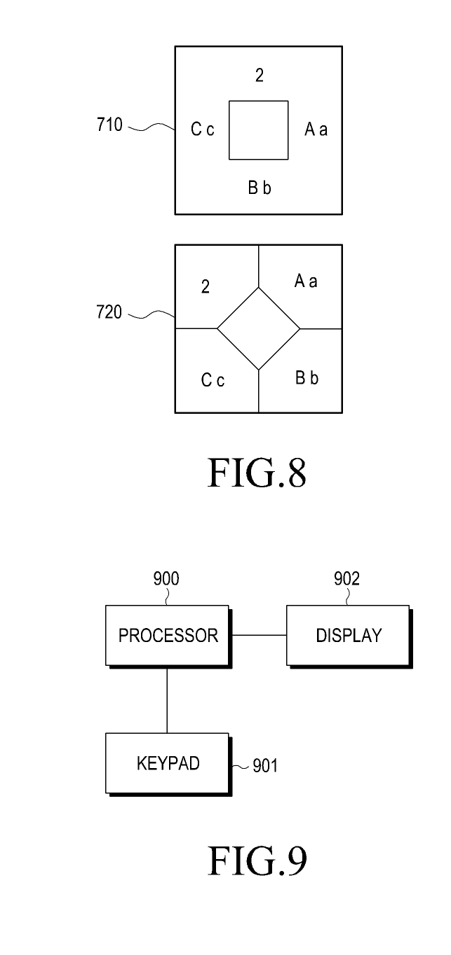

FIG. 8 illustrates level two keys on clip keypads according to embodiments of the present invention.

Referring to FIG. 8, when a user presses character key 420 or 520 including “2CBA”, as illustrated in FIGS. 5 and 6, the level two key 710 or 720 is displayed. Each of the level keys 710 and 720 includes separate display areas for “2”, “C”, “B”, and “A”. Accordingly, in level keys 710 and 720 “2” is displayed in an area for selection by a subsequent pressing of character key 420 or 520, “C” displayed in area for selection by a subsequent pressing of character key 430 or 530 (while “c” will be selected when character key 430 or 530 is pressed twice), “B” is displayed in area for selection by a subsequent pressing of character key 440 or 540 (while “b” will be selected when character key 440 or 540 is pressed twice), and “A” is displayed in area for selection by a subsequent pressing of character key 450 or 550 (while “a” will be selected when character key 450 or 550 is pressed twice).

Alternatively, in a mobile terminal including a touch screen display, the numbers and characters displayed in the level zero keys 610 and 620 in FIG. 7 and the level two keys 710 and 720 in FIG. 8 can be selected by pressing the actual display areas displayed on the touch screen display, instead of pressing the corresponding character keys 410, 420, 430, 440, 450, 460, 470, 480, 510, 520, 530, 540, 550, 560, 570, and 580.

As another alternative, in a mobile terminal including a touch screen display that displays the keypads illustrated in FIGS. 5 and 6, i.e., a terminal without a physical keypad, when one of the a character keys are pressed in a first clip key 401 or 501, or a second clip key 402 or 502 on the touch screen, the first clip key 401 or 501 of the displayed keypad can be replaced with a corresponding level key. For example, the level keys 610 and 620 can be displayed instead of the second clip keys 402 and 502 in the displayed keypad of FIGS. 5 and 6. Alternatively, a corresponding level key can be displayed in addition to the displayed keypads of FIGS. 5 and 6, e.g., in another area of the display or as a pop-up window.

Alternatively, instead of selecting an uppercase version or a lowercase version of a letter based on a number of key presses, as described above, the selection of the uppercase version or the lowercase version of a letter may be based on the length of a key press, e.g., an uppercase letter is entered for a long press and a lowercase letter is entered for a short press.

In accordance with an embodiment of the present invention, instead of simultaneously displaying both lowercase and uppercase versions of a letter in an area of a level key as illustrated in FIG. 8, uppercase versions of a letter could be displayed on the level key for a predetermine time T, e.g., 2 second, and if a user does not select a character before T expires, the uppercase versions of the letters are replaced with lowercase version of the letters.

In accordance with an embodiment of the present invention, in order to improve information input efficiency, characters displayed on a keypad include numerical characters 0-9, 26 English letter, *, #, and a symbol set. Accordingly, M i.e., the total number of characters displayed on the keypad, is 39. Consequently, a character such as a numeral or an English letter can be found on the keypad directly when the character is to be input.

If a Chinese character is to be input, Chinese spelling or stroke characters corresponding to the Chinese character are the specific characters to be input. Generally, the stroke keys are displayed by combining with the numerical keys 1-5, which are “-” (cross), “|” (erect), “□” (skimming), “ [symbol] ” (dot) and “□” (cross breaks) respectively (not shown in the keyboard of figures), and are applicable to the above-described embodiments of the present invention.

In accordance with an embodiment of the present invention, two working modes are provided for character input; an editing mode and a non-editing mode. When an editing frame of the mobile terminal is activated, the input method is in the editing mode; otherwise, the input method is in the non-editing mode.

For example, when the input method is in the non-editing mode, pressing the keys of the keypad directly enters 0-9, *, or #, i.e., no level keys are displayed for entering a character. Under this mode, telephone number can be input rapidly, by pressing a key once to entering each number.

When the input method is in the editing mode, all characters can be input in two button presses, i.e., a first character key selection and a second level key selection.

FIG. 9 is a block diagram illustrating a mobile terminal according to an embodiment of the present invention.

Referring to FIG. 9, the mobile terminal includes a processor 900, a keypad 901, and a display 902. The processor 900 receives input from a user via the keypad 901, and controls the display 902 to display levels keys and the character input, as described in the embodiments above. The keypad 901 can be embodied as a physical keypad, e.g., in the configurations as illustrated in FIGS. 2, 4, and 5, or if the display 902 is a touch screen display, as a virtual keypad displayed thereon.

The display 902 displays the level keys as illustrated in FIGS. 3, 4, 7, and 8.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A mobile terminal comprising:
a keypad including a plurality of keys that receive a first input from a user, wherein the plurality of keys correspond to a plurality of characters;
a display; and
a processor that
receives the first input from the user through a key of the keypad,
controls the display to display a level key, wherein the level key includes a set of characters corresponding to the key and displays each character of the set of characters in separate areas, and the separate areas correspond to the plurality of keys of the keypad,
receives a second input through one of the plurality of keys of the keypad, and
controls the display to display a character from among the set of characters displayed in the separate areas of the level key corresponding to the second input received through the one of the plurality of keys of the keypad, as a character entry.

2. The mobile terminal of claim 1, wherein the plurality of characters comprise:
numerical characters;
letter characters; and
symbols.

3. The mobile terminal of claim 1, wherein the plurality of characters are arranged on the plurality keys based on usage frequencies of the plurality of characters.

4. The mobile terminal of claim 3, wherein each of the plurality of keys includes a character having a high usage frequency and a character having a low usage frequency.

5. The mobile terminal of claim 1, wherein each of the plurality of keys includes a numerical character and a letter character.

6. The mobile terminal of claim 5, wherein the mobile terminal operates in one of an editing mode and a non-editing mode,
wherein, in the non-editing mode, the processor controls the display to display a numerical character corresponding to the first input, and
wherein, in the non-editing mode, the processor controls the display to display the level key corresponding to the first input.

7. A mobile terminal comprising:
a touch screen display that displays a virtual keypad including a plurality of keys that receive a first input from a user, wherein the plurality of keys correspond to a plurality of characters; and
a processor that
receives the first input from the user through a key of the keypad,
controls the touch screen display to display a level key, wherein the level key includes a set of characters corresponding to the key and displays each character of the set of characters in separate selectable areas,
receives a second input through one of the separate selectable areas, and
controls the touch screen display to display a character from among the set of characters displayed in the separate selectable areas of level key corresponding to the second input, as a character entry.

8. The mobile terminal of claim 7, wherein the plurality of characters comprise:
numerical characters;
letter characters; and
symbols.

9. The mobile terminal of claim 7, wherein the plurality of characters are arranged on the plurality keys based on usage frequencies of the plurality of characters.

10. The mobile terminal of claim 9, wherein each of the plurality of keys includes a character having a high usage frequency and a character having a low usage frequency.

11. The mobile terminal of claim 7, wherein each of the plurality of keys includes a numerical character and a letter character.

12. The mobile terminal of claim 11, wherein the mobile terminal operates in one of an editing mode and a non-editing mode,
wherein, in the non-editing mode, the processor controls the display to display a numerical character corresponding to the first input, and
wherein, in the non-editing mode, the processor controls the display to display the level key corresponding to the first input.

13. The mobile terminal of claim 7, further comprising a physical keypad including a plurality of physical keys that receive the first input from a user,
wherein the plurality of keys correspond to the plurality of characters, and
wherein the separate areas of the level key correspond to the plurality of physical keys of the physical keypad.

14. A method of character entry in a mobile terminal, the method comprising:
receiving a first input from a user through a key of a keypad including a plurality of keys, wherein the plurality of keys correspond to a plurality of characters;
displaying a level key corresponding to the first input, wherein the level key includes a set of characters corresponding to the key and displays each character of the set of characters in separate areas,
receiving a second input selecting a character from among the set of characters displayed in the separate areas of the level key, and
displaying the character as a character entry.

15. The method of claim 14, wherein the separate areas of the level key correspond to the plurality of keys of the keypad, and
wherein the second input is received through one of the plurality of keys of the keypad.

16. The method of claim 14, further comprising displaying the keypad on a touch screen display of the mobile terminal.

17. The method of claim 16, wherein the first input is received when the user presses the key displayed on the touch screen display.

18. The method of claim 17, wherein the second input is received when the user presses one of the separate areas of the level key displayed on the touch screen display.

19. The method of 16, wherein the level key is displayed in a pop-up window on the touch screen display.

20. The method of 16, wherein the level key is displayed over the keypad.
